(19) United States
(12) Patent Application Publication
(10) Pub. No.: US 2013/0254649 A1
(43) Pub. Date: Sep. 26, 2013

(54) ESTABLISHING USER CONSENT TO COOKIE STORAGE ON USER TERMINAL EQUIPMENT

(71) Applicants: Michael O'Neill, Oxford (GB); Valerie Alexandra O'Neill, Oxford (GB)

(72) Inventors: Michael O'Neill, Oxford (GB); Valerie Alexandra O'Neill, Oxford (GB)

(21) Appl. No.: 13/489,336

(22) Filed: Jun. 5, 2012

Related U.S. Application Data
(60) Provisional application No. 61/494,159, filed on Jun. 7, 2011.

(51) Int. Cl. G06F 17/22

(52) U.S. Cl. CPC G06F 17/2247
USPC 715/234

(57) ABSTRACT

The present invention relates in general to a system, method and apparatus for obtaining the explicit consent from a person who is requesting access to internet content, such as a web page or image, to have cookies, perhaps used for used for Tracking or Behavioural Advertising purposes, stored on their computer or device. In particular, the present invention relates to a system, method and apparatus whereby website Publishers place a page element that displays a recognisable icon to their visitors which can initiate a transaction whereby consent can be obtained for cookie storage. If consent is refused cookies are automatically removed from the visitor's computer or device. Cookies classed as 3^{rd} party in that they are placed by web server other that controlled by the Web Publisher, can also be stopped by the invention.

This non provisional patent application claims the benefit of USPTO provisional application 61/494,159 ESTABLISHING USER CONSENT TO COOKIE STORAGE ON USER TERMINAL EQUIPMENT Filed Jun. 7, 2012

### DESCRIPTION

The present invention relates in general to a system, method and apparatus for obtaining the explicit consent from a person who is requesting access to internet content, such as a web page or image, to have cookies, perhaps used for used for Tracking or Behavioural Advertising purposes, stored on their computer or device. In particular, the present invention relates to a system, method and apparatus whereby website Publishers place a page element that displays a recognisable icon to their visitors which can initiate a transaction whereby consent can be obtained for cookie storage. If consent is refused cookies are automatically removed from the visitor's computer or device. No change to the Publisher's web site is necessary.

The Internet is a global interconnection of computers and computer networks. One of the benefits of the Internet is that many millions of users have access to shared information of the World Wide Web, whereby pages of text and graphic information in HTML or other formats are transmitted by a Hyper Text Transfer Protocol (HTTP). The Internet and its supporting structures are discussed in detail in Requests for Comments (RFCs), available from www.faqs.org and elsewhere. Reference is made in particular to RFC2616 (Hypertext Transfer Protocol—HTTP/1.1), RFC1738 (Uniform Resource Locators) and RFC2965 (HTTP State Management Mechanism).

Privacy advocates have been calling attention to issues of pervasive online tracking for some time. Online tracking refers to the mechanisms by which some or all of our reading and other activities on the Web are recorded by third parties for purposes such as Behavioural Targeting, often without our knowledge or permission. Some web servers cause small pieces of data, called cookies, to be stored on a user's computers for this purpose, in such a way that they are retransmitted to the web server in subsequent content requests. The use of Cookies is described in RFC2965 (HTTP State Management Mechanism).

There are several ways whereby a user can disable cookies, for instance using their Browser settings, but this can cause problems in accessing websites that use cookies to associate them with Log In or “shopping trolley” information. Even if this is limited to third party cookies as used by advertisers the user may wish to opt-in to the use of such cookies to some advertisers. Users can also use software utilities that remove cookies from request packets, but these are often difficult to configure in the case that the user wishes to opt-in to cookie use to some specific advertisers or websites. Some browsers and utility software include an option whereby content request packets have a “Do Not Track” HTTP header inserted in order to signal to receiving websites or advertisers that the associated cookie should not be used for online tracking purposes. This has the problem that it relies on the receiving website honouring the request not to be tracked, and it also does not supply a way for a benign website or advertiser to specifically ask the user if the will accept online tracking in this case.

An aim of the present invention is to address the disadvantages and problems of the prior art, as discussed above or elsewhere.

According to the present invention there is provided an apparatus, method and system as set forth in the appended claims. Preferred features of the invention will be apparent from the dependent claims, and the description which follows.

In one aspect of the present invention there is provided a method for a Website Publisher obtaining the. HTML code for a cookie consent Button from a Service. This HTML code is inserted into one or more of the Web Pages administered by the Publisher. This Button consists of visible elements such as a recognisable Icon and descriptive text, along with interpretive Code such as JavaScript that is executed in the Visitor's Browser context whenever the Web Pages are displayed. The Icon and descriptive text notify the Visitor that the Button can be used to determine their consent or otherwise to storing the Publisher's cookies. One or more of the elements within the button have encoded within them Publisher Information about the Publisher, such as a unique Publisher ID identifying number, and the Host Domain used by the Publisher to identify their cookies. An example of such an element is an IFRAME element with the “src” attribute targeting the Service Content Display and the Publisher Information encoded into the resource query string. The Service Content Display returns the HTML that displays the Button (The Displayed Button) to the Visitors Browser, and the visible elements within the Displayed Button are the Icon and a link, or anchor tag, that causes the Visitor's Browser to display a window showing a Consent Form hosted by the Service when the Icon or other visible element in the Displayed Button is clicked. This Consent Form asks the Visitor for their consent to store persistent cookies from the Publisher, and also their consent or otherwise to store a cookie from the Service, the Service Cookie. The Service Cookie is placed in the Visitor's Browser within a single particular area such as the one allocated to cookies from the Service Provider's Web Server identified by the URL Host , also called the Service Provider's domain. The Service Cookie will contain a Visitor ID or index number that forms part of the key that addresses a Visitor Entry record in a Visitor Cookie Consent database. The Service Cookie can then, if consent is given by the Visitor, be set to be persistent and stored on the Visitors computer. When the Service receives a POST HTTP request containing the Consent Form data it updates the Agreed Field within the Visitor Entry Record within the Visitor Cookie Consent database to reflect the Visitor's consent status.

The Publisher Information that is stored in the Button HTML is passed to the Service when the Button is displayed and the Displayed Button Is returned. From this the Service can decode the identity of the Publisher, the Publisher ID. If a Service Cookie is present the Visitor ID is decoded from its value. If there is no Service Cookie present a new Visitor ID is generated and encoded into a new Service Cookie that is either returned in a Set-Cookie header to the Visitor's browser, or passed to a JavaScript function embedded in the page which places the cookie. The Publisher ID is combined with the Visitor ID to create a key that selects a Visitor Entry Record within the Visitor Cookie Consent database. If no such record exists a new one is created and inserted into the database.

A field within the Visitor Entry Record, the Agreed Field, encodes a Consent Given value indicating whether the Visitor, identified by the Visitor ID, has given consent to cookies from the Publisher, identified by the Publisher ID. When the Displayed Button is returned to the Visitors Browser it contains a reference to the Service Cookie in a Set-Cookie Response Header and the Consent Given value is encoded in the response within a, for example, nonvisible element within the Displayed Button.

The Code loaded into the Visitor's Browser can detect the existence of the encoded Consent Given value when the Displayed Button is rendered. If the Consent Given value is “false” then the Code running in the context of the Service host domain signals a Code function in the Publisher host domain that deletes cookies received in the response from the Visitor's Browser in that context. This ensures that no cookie encoded in a Set-Cookie header within the HTTP response to the Publisher's Web Page or created by Code such as JavaScript functions included in the page is sent back in subsequent requests to the Publisher's Web Server.

The Visitor Entry Record also contains a field, the 3^{rd} Party Consent Record that contains a list of identifiers of 3^{rd} Party Content Providers where consent by the visitor identified by the Visitor ID has been registered. The assembly HTML elements that select the 3^{rd} Party Content can be stored in the Visitor Entry Record and delivered to the Visitor's Browser where a Code function can cause it to be rendered when Visitor consent to that3^{rd} party Content has been registered. An image the content can also be stored so in the Visitor Entry Record so that, in the case of a Visitor not having agreed to cookies from the 3^{rd} Party Provider, the image can be rendered instead of the original 3^{rd} Party Content.

The present invention may, in some embodiments, be implemented as computer software. The invention also extends to a program storage medium having computer executable instructions stored thereon to perform any of the methods described herein.

For a better understanding of the invention, and to show how embodiments of the same may be carried into effect, reference will now be made, by way of example, to the accompanying diagrammatic drawings in which:

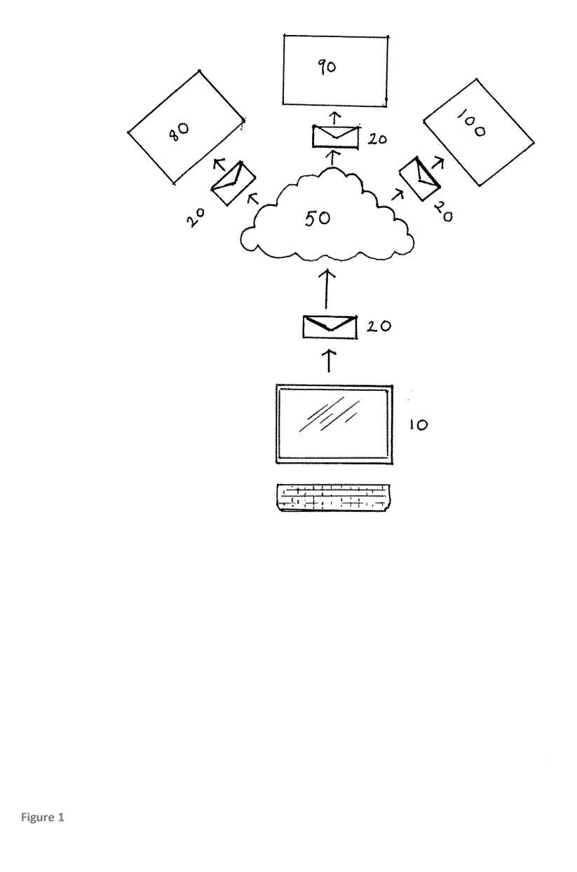

FIG. 1 is a schematic overview of a system and apparatus as employed in first preferred embodiments of the present invention;

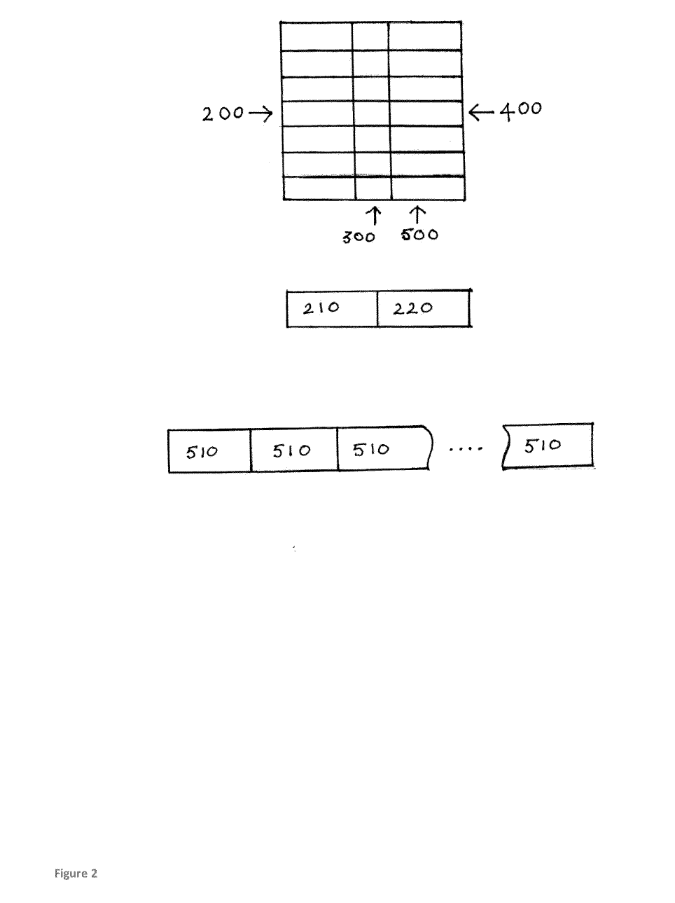

FIG. 2 shows a schematic representation of a Visitor Entry Record in a Visitor Cookie Consent Database.

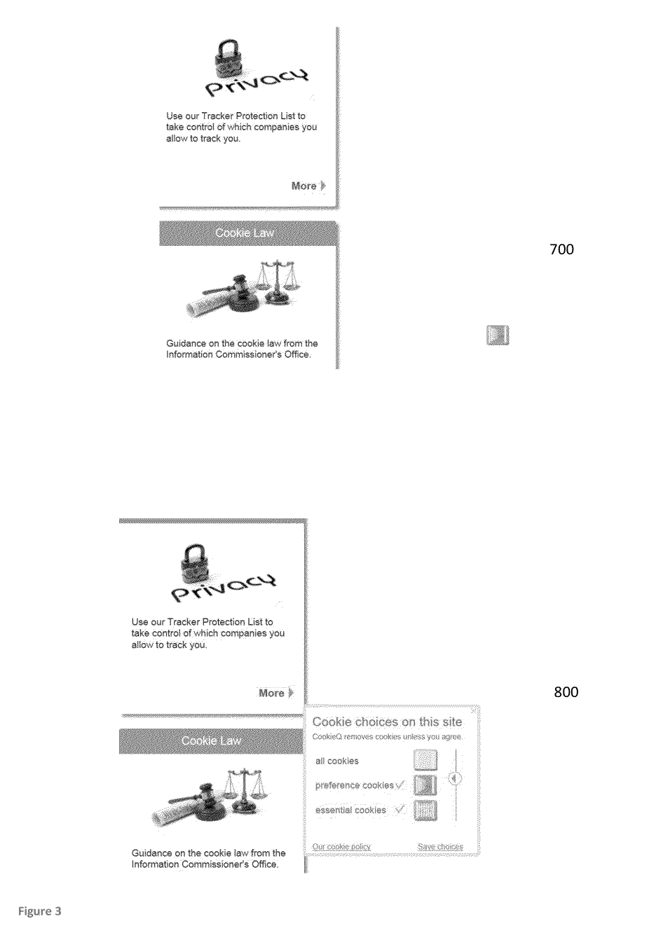

FIG. 3 shows the visible elements of a Displayed Button.

Referring to FIG. 1, a schematic overview is shown of a system and apparatus as employed in the first preferred embodiments of the present invention. In this first example embodiment, an end-user computer 10 sends transport level HTTP content request packets 20 over the Internet 50 to access pages on the Web Site hosted on the Publishers Web Server 80. The content returned includes HTML that addresses content on the Web Server belonging to the Service 100.

Referring to FIG. 2, a schematic overview is shown of a key 200 formed by combining a Publisher ID 210 and a Visitor ID 220. The key 200 selects a Visitor Entry Record 400 in the Visitor Cookie Consent Database 400. This record contains the Consent Given value encoded in the Agree Field 300.

The Visitor Entry Record may also contain a 3^{rd} Party Consent Record 500. This record consists of the appended list of 3^{rd} Party Consent Status values 510. Each of these indicates whether the visitor identified by the Visitor ID has consented to cookies being placed by a particular 3^{rd} Party Content provider. Each 3^{rd} Party Content Provider can either be identified by a particular name encoded within the 3^{rd} Party Consent status or by the ordinal position of the 3^{rd} Party Consent status 510 within the 3^{rd} Party Consent Record.

Referring to FIG. 3, this shows an example format of a Cookie Consent Button contained within a Web Page 700. When the Cookie Consent Button is clicked a panel 800 is presented to the user giving them the ability to opt-in to or opt-out of receiving cookies.

### Diagrams

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with this specification in connection with this application and which are open to public inspection with this specification, and the contents of all such papers and documents that are incorporated herein by reference. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method for use ascertaining from a visitor to a web page whether they agree to have 1^{st} party cookies stored in their computer, and removing them if they do not, comprising the steps of:
a. Generate the HTML code for a Cookie Consent Button such that a web page Publisher can add it to the mark-up of one or more of their web pages. The HTML includes elements that include or reference interpretive scripting Code, using a language such as JavaScript, that are executed in the Visitor's Browser in the context of the Publisher's Host domain.
b. Incorporating into the button an element that addresses web resident content that encodes a number that identifies the web site Publisher, the Publisher ID, such that it is encoded into a request URL.
c. Respond to requests for Internet hosted content from the button, to detect the presence of a Service Cookie in the request headers, render an HTML element such as a Cookie Consent Button to the Web Page Visitor, and decode the Publisher ID from the request URL.
d. Decode a Visitor ID number from the Service Cookie.
e. Combine this Visitor ID number with the Publisher ID to generate a key that selects a Visitor Entry Record within a Visitor Cookie Consent Database.
f. Include in the response the visible elements to render the Button, along with elements that encode the Visitor's consent agreement record for the particular Publisher ID.
g. Depending on the returned Visitor's Consent Given value, execute scripting code in the Visitors Browser in the context of the page returned by the Publisher that causes the cookies returned in the response from the Publisher to be deleted. This is done by placing a cookie with the same name as the cookie to be deleted with an expiry date set into the past, so that the browser will immediately delete it.
h. If cookies are removed in this way they will not be sent in the header of subsequent requests to the website, and so will not be able to be used for any purpose including behavioural tracking.

2. A method recited in claim 1 of registering consent for cookies described and covered by a single Cookie Policy Document across multiple web sites. The Service Cookie resides in the Service Provider's Domain in a Visitor's Browser and the single Unique User Identity, the Visitor ID, encoded within it combined with the Publisher ID identifies a single Visitor Consent Record where the Consent Given Value records consent to a single Cookie Policy Document.

3. A method recited in claim 1 for use for stopping the placement of cookies in a visitor's browser by 3^{rd} party content embedded in a Web Publisher's web page if they have not agreed to receive said cookies.
a. Include in the response, referred to in paragraph f in claim 1, the visible elements to render the Button, along with elements that encode the Visitor's consent agreement record for the 3^{rd} party Content Providers indicated by the 3^{rd} Party Request Mask.
b. Generate a 3^{rd} Party Allow Record which is the subset of the 3^{rd} Party Content Providers indicated in the 3^{rd} Party Request Mask but not present in the 3^{rd} Party Consent Record.
c. Return the 3^{rd} Party Allow Record encoded into an HTML element such as a hidden input element.
d. Return a URL of an image of the 3^{rd} Party content which is the same width and height as the original 3^{rd} Party Content. This image is hosted by the Service without placing cookies and can be rendered instead of the 3^{rd} Party Content if the visitor has not given consent for them.
e. Consent for 3^{rd} Party Content cookies is registered by visitors clicking a Consent Button as described in claim 1 present on the 3^{rd} Party Content Provider's website or on the Service Provider's website.

3. A method recited in claim 3 for stopping the placement of cookies in a visitor's browser by ^{3rd} party content embedded in a Web Publisher's web page if they have not agreed to receive said cookies where script in the Web Publisher's web page, the 3^{rd} Party Script, is inhibited from executing by amendments to the script such as setting the type attribute of the 3^{rd} Party Script tag to “text/plain” rather than “text/JavaScript”. A Code function in the Associated JavaScript can selectively enable the execution of the 3rd Party Script when the 3^{rd} Party Allow Record indicates that the visitor has agreed to cookies from that 3^{rd} Party Provider.
